(19) United States
(12) Patent Application Publication
(10) Pub. No.: US 2006/0200744 A1
(43) Pub. Date: Sep. 7, 2006

(54) Distributing and displaying still photos in a multimedia distribution system

(76) Inventors: Adrian Bourke, San Diego, CA (US); David Lubinksy, San Diego, CA (US)

Correspondence Address: CHRISTIE, PARKER & HALE, LLP, PO BOX 7068, PASADENA, CA, 91109-7068, US

(21) Appl. No.: 11/327,543

(22) Filed: Jan. 5, 2006

Related U.S. Application Data
(63) Continuation-in-part of application No. 11/016,184, filed on Dec. 17, 2004.
Application No. 11/016,184 is a continuation-in-part of application No. 10/731,809, filed on Dec. 8, 2003.
(63) Continuation-in-part of application No. PCT/US04/41667, filed on Dec. 8, 2004.
(60) Provisional application No. 60/641,999, filed on Jan. 6, 2005.

(51) Int. Cl. G06F 17/00

(52) U.S. Cl. 715/500.1

(57) ABSTRACT

Multimedia file formats that accommodate still photos encoded as video sequences are described. In addition, encoding multimedia files to include still photos as encoded video sequences and decoding multimedia files containing still photos encoded as video sequences are discussed. Many of the multimedia files described include information that enable a user to view the encoded video sequences of the still photos via an interactive menu. In several examples, the encoded video sequences are accessed via a menu showing thumbnail images of each of the still photos contained within the multimedia file. In many examples, the encoded video sequences are displayed in the manner of a slide show of the encoded still photos. In a number of examples, menus are used to organize of encoded still photos into digital albums. One embodiment of the invention includes at least one still photo encoded as an encoded video sequence and menu information that references the location of each encoded video sequence.

### CROSS-REFERENCE TO RELATED APPLICATION(S)

This application is a Continuation-In-Part of U.S. patent application Ser. No. 11/016,184 filed on Dec. 17, 2004, which is a Continuation-In-Part of U.S. patent application Ser. No. 10/731,809 filed on Dec. 8, 2003. In addition, this application is a continuation-in-part of PCT Patent Application No. PCT/US2004/041667 filed on Dec. 8, 2004 and claims the benefit of U.S. Provisional Patent Application Ser. No. 60/641,999 filed on Jan. 6, 2005. The disclosure of each above-referenced application is incorporated herein by reference in its entirety.

### BACKGROUND TO THE INVENTION

The present invention relates generally to the encoding, distribution and decoding of multimedia files and more specifically to the encoding, distribution and decoding of multimedia files that include still photographs encoded as video frames.

Many digital cameras exist that possess the ability to take digital still photographs. Still photographs taken using digital cameras are typically stored in file formats appropriate to a single still photograph. A common format is a bit map, which includes a piece of information for each pixel in the photograph. Many still photograph formats such as the JPEG standard, developed by the Joint Photographic Experts Group, use compression to reduce the amount of data required digitally store a still photograph.

Video sequences can also be captured using digital video cameras and a number of formats exist for storing digital video sequences. As with digital still photographs, digital video formats often use compression to reduce the number of bits required to represent the video sequence. When a sequence of video frames is compressed, the compression ratio can be increased by utilizing the characteristics of adjacent video frames in addition to the characteristics of the frame itself.

### SUMMARY OF THE INVENTION

Embodiments of the present invention can encode, distribute and decode multimedia files that include menu information and digital still photographs (photos) encoded as a video sequence (often of a single video frame). In one aspect of the invention, the menu information and the encoded digital still photos can be used by an embodiment of a decoder in accordance with the present invention to render an interactive menu that can provide a slide show or digital photo album(s) of the encoded still photos. In another aspect of the invention, the menu information defines a state machine that can be used by decoder in accordance with the present invention to determine the menus/media to display and appropriate menu transitions to perform in response to user instructions. One embodiment of the present invention includes at least one still photo encoded as an encoded video sequence and menu information that references the location of each encoded video sequence.

In a further embodiment of the invention, each encoded video sequence is stored within the multimedia file as a separate track of encoded video.

In another embodiment of the invention, each track of encoded video complies with the RIFF format.

In a still further embodiment of the invention, the menu information includes references to encoded video sequences that provide background video and references to information that can be used to generate menu overlays.

In still another embodiment of the invention, the menu information includes information directing that an encoded video sequence of a still photo be repeatedly displayed until interrupted by a user instruction.

In a yet further embodiment, the menu information defines a state machine. In yet another embodiment, the state machine is hierarchical. In a further embodiment again, the state machine includes a parent/child hierarchy.

Another embodiment again also includes encoded audio information.

In a further additional embodiment, each video sequence includes at least one encoded frame of video.

In another additional embodiment, each video sequence includes a plurality of encoded frames of video.

A still yet further embodiment includes a video encoder configured to encode the at least one digital still photo as an encoded video sequence and a menu generator configured to generate menu information that references the encoded video sequences within a multimedia file.

In still yet another embodiment, the video encoder is configured to encode the at least one digital still photo as an encoded video sequence by decoding the digital still photo and encoding the decoded digital image as an encoded video sequence.

In a still further embodiment again, the video encoder and menu generator are implemented using a microprocessor.

In still another embodiment again, each encoded video sequence includes at least one frame of encoded video.

In a still further additional embodiment, each encoded video sequence includes a plurality of frames of encoded video.

In still another additional embodiment, the menu information includes a direction to repeatedly play an encoded video sequence until a user instruction is received.

In a yet further embodiment again, the menu information defines a state machine.

In yet another embodiment again, the state machine is hierarchical.

In a yet further additional embodiment, the hierarchy is a parent/child hierarchy.

Yet another additional embodiment includes decoding circuitry configured to decode encoded video sequences and a parser configured to construct a state machine from menu information.

In a further additional embodiment again, the state machine is hierarchical.

In another additional embodiment again, the hierarchy is a parent/child hierarchy.

Another further embodiment also includes control circuitry configured to use the state machine and user instructions to determine when to display the encoded video sequences of still photos.

In still another further embodiment, the state machine defined by the menu information includes a direction to repeatedly display one of the encoded video sequences of a still photo until a user instruction is received for output on a rendering device and the control circuitry is configured to respond to the direction to repeatedly display a video sequence until interrupted by a user command by repeatedly decoding an encoded video sequence, outputting the decoded video sequence and waiting for a user command.

In yet another further embodiment, the encoded video sequence includes a single encoded video frame.

In another further embodiment again, the encoded video sequence includes a plurality of encoded video frames.

In another further additional embodiment, the decoder is configured to resize the encoded video sequence for display on the rendering device.

In still yet another further embodiment, the resizing includes resampling the video sequence.

In still another further embodiment again, the resizing includes cropping the video sequence.

In still another further additional embodiment, resizing includes reducing the size of the video sequence to occupy a smaller area of the rendered display.

In yet another further embodiment again, the state machine is hierarchical state machine.

In yet another further additional embodiment, hierarchy is a parent/child hierarchy.

An embodiment of the method of the invention includes, constructing a state machine from menu information stored in a file, receiving user instructions, determining the media to render in response to the user instruction using the state machine. A further embodiment of the method of the invention also includes rendering a video sequence of a still photograph.

### BRIEF DESCRIPTION OF THE DRAWINGS

FIG. 1 is a screen shot of an embodiment of a menu in accordance with an embodiment of the invention showing a background image, where the background image includes thumbnail images of still photos that are accessible via the menu.

FIG. 2.0. is a schematic diagram of a multimedia file in accordance with an embodiment of the invention.

FIG. 2.0.1. is a schematic diagram of a multimedia file in accordance with an embodiment of the invention that includes ‘RIFF’ chunks, one of which includes a ‘DMNU’ chunk.

FIG. 2.1. is a schematic diagram of a ‘DMNU’ chunk in accordance with an embodiment of the invention.

FIG. 2.2. is a conceptual diagram of menu chunks contained in a ‘DivXMediaManager’ chunk in accordance with an embodiment of the invention.

FIG. 2.3. is a conceptual diagram of menu chunks contained in a ‘DivXMediaManager’ chunk in accordance with another embodiment of the invention.

FIG. 2.4. is a conceptual diagram illustrating the relationships between the various chunks contained within a ‘DMNU’ chunk in accordance with an embodiment of the invention.

FIG. 3 is a block diagram of a system for generating a multimedia file in accordance with an embodiment of the invention.

FIG. 4 is a block diagram of a system to generate a ‘DMNU’ chunk in accordance with an embodiment of the invention.

FIG. 5 is a conceptual diagram of a media model in accordance with an embodiment of the invention.

FIG. 6 is a block diagram of a decoder in accordance with an embodiment of the invention.

FIG. 7 is an conceptual diagram of a menu displayed in accordance with an embodiment of the invention.

FIG. 8 is a screen shot of a menu displayed in accordance with an embodiment of the invention.

FIG. 9 is a conceptual diagram showing the sources of information that can be used in accordance with an embodiment of the present invention to generate the menu display illustrated in FIG. 7.

### DETAILED DESCRIPTION OF THE INVENTION

1. Introduction

The patent applications referred to above describe systems and methods for encoding a plurality of video tracks and writing the encoded video tracks to a single file that also includes menu information. Embodiments of the present invention are capable of encoding still photos and other images as encoded video sequences that can be included in a multimedia file similar to those described in the above-referenced applications. In addition, the menu information can include data that can be used by decoders to build a state machine. The state machine is often hierarchical and defines an interactive menu system that can be used by the decoder to access the still photos encoded as video sequences.

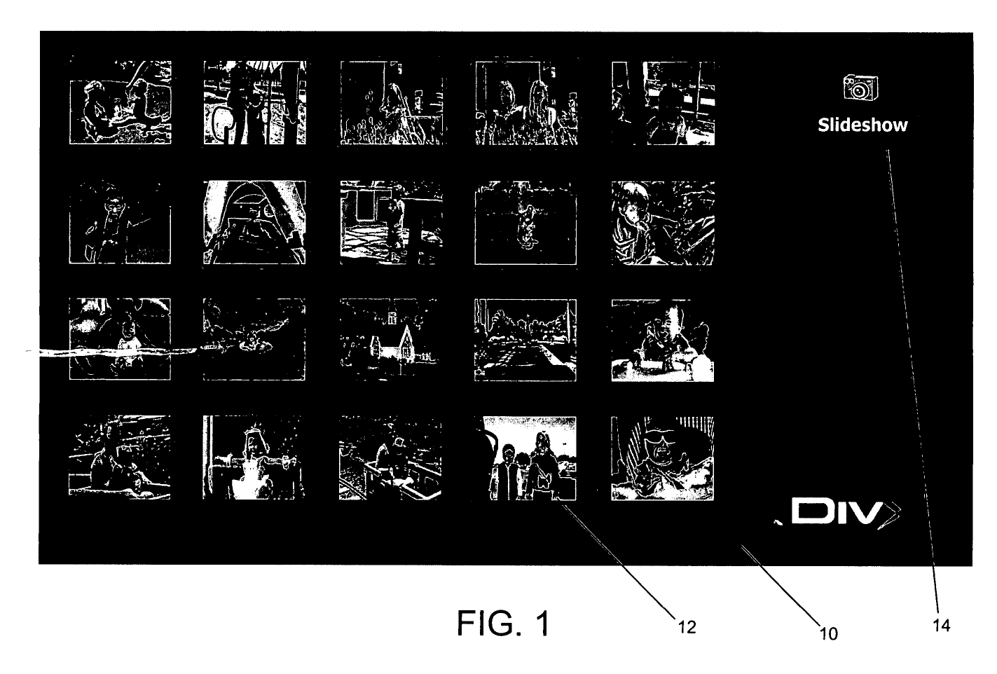

Multimedia files including sill photos encoded as video sequences can be distributed to a player for display to an end user. A menu 10 of photo thumbnails 12, as shown in FIG. 1, can also be provided to allow the user to navigate and view the photos. Clicking on a particular thumbnail causes the player to display a still photo in full screen format. When displaying the still photo, the player plays the encoded video sequence for the still photo as it would play any other encoded video sequence. If the playback rate for rendering video is identified as 30 frames per second, the encoded video sequence for a still photo is played accordingly. Irrespective of the frame rate, the image created by rendering the encoded video sequence will appear to be “still”, because the same video frame is played over and over again. The playback of an encoded video sequence of a still photo need not involve real-time image processing because each image is pre-rendered and encoded as a video sequence that adheres to a format capable of being decoded by a player capable of decoding a multimedia file formatted as described in the above-referenced applications.

As indicated above, menu information within a multimedia file containing still photos encoded as video sequences can enable navigation between the still photos. For example, a user may switch from photo to photo by navigating a thumbnail menu. In addition, the thumbnail menu can also include a button 14 that initiates a slideshow of the still photos. A slideshow can involve repeating the display of an encoded video sequence for a still photo for a predetermined period of time and then playing an encoded video sequence for another of the still photos for a predetermined period of time until the video sequence for each still photo has been displayed. In several embodiments, the multimedia file contains a separate encoded video sequence that includes a slide show of the still photos complete with transition effects (such as a fade effect). In many embodiments, encoded video sequences of still photos contained within a multimedia file are associated into albums and a user can use the menu system to navigate between albums and play slide shows for individual albums.

2. Multimedia Files Containing Still Photos

According to one embodiment, a video file adhering to the multimedia file format described in the above-referenced applications may be generated with a number of still photos as a source of video information. In embodiments that use this multimedia file format, the still photos can be stored as encoded video sequences in separate ‘MRIF’ chunks. The encoded video sequences for each of the photos can then be accessed using menu information stored within the multimedia file. In a number of embodiments, a user can interact with an interface that automatically generates encoded video sequences and menu information as the user uploads digital still photos via the interface.

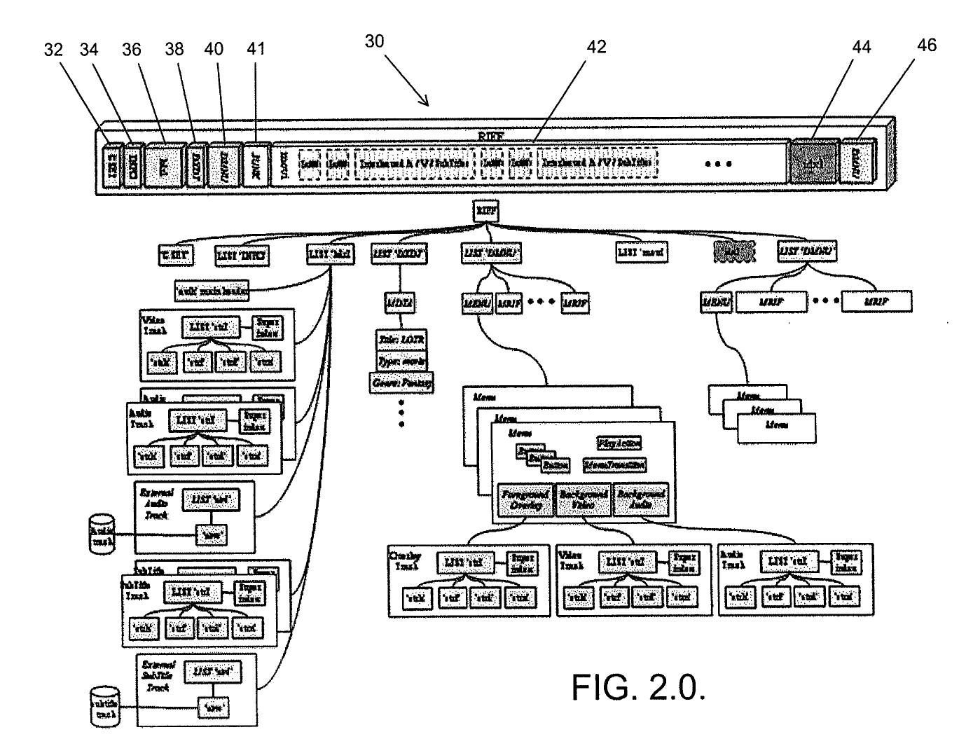

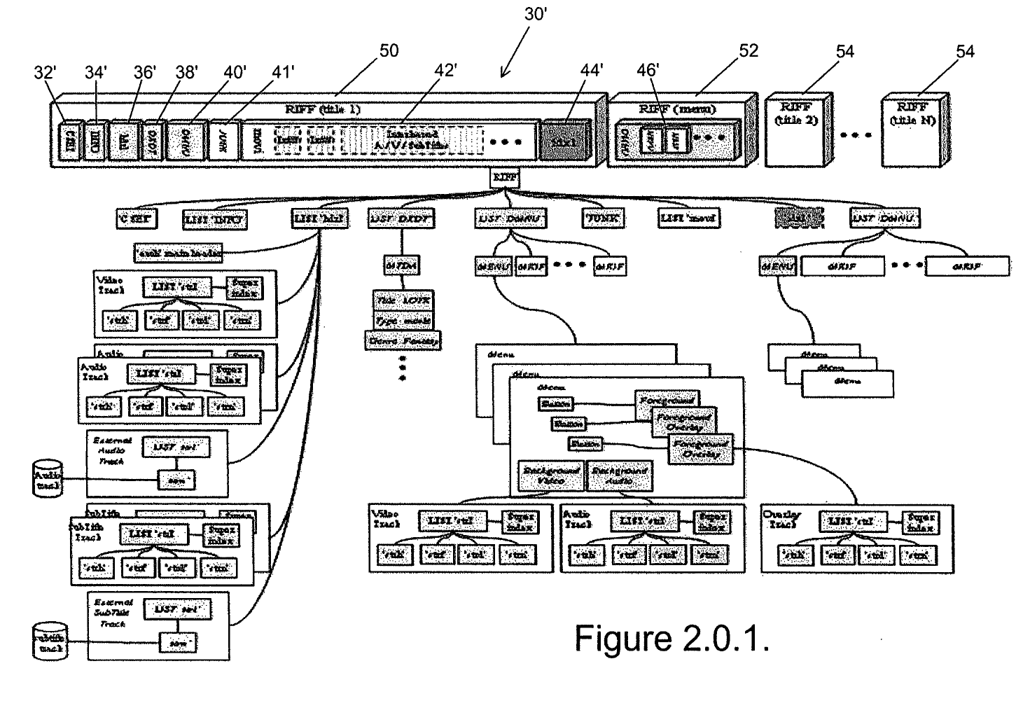

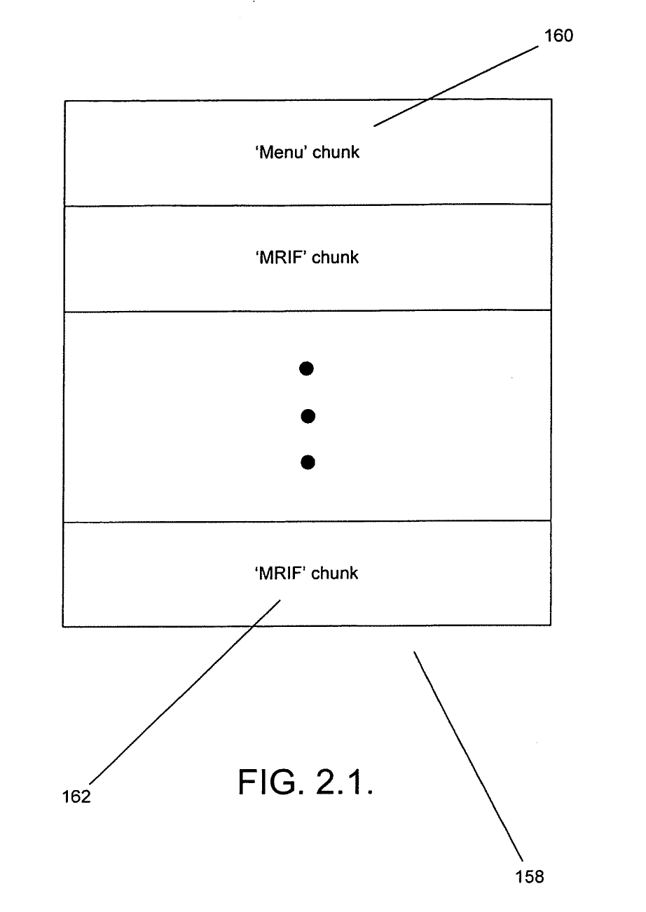

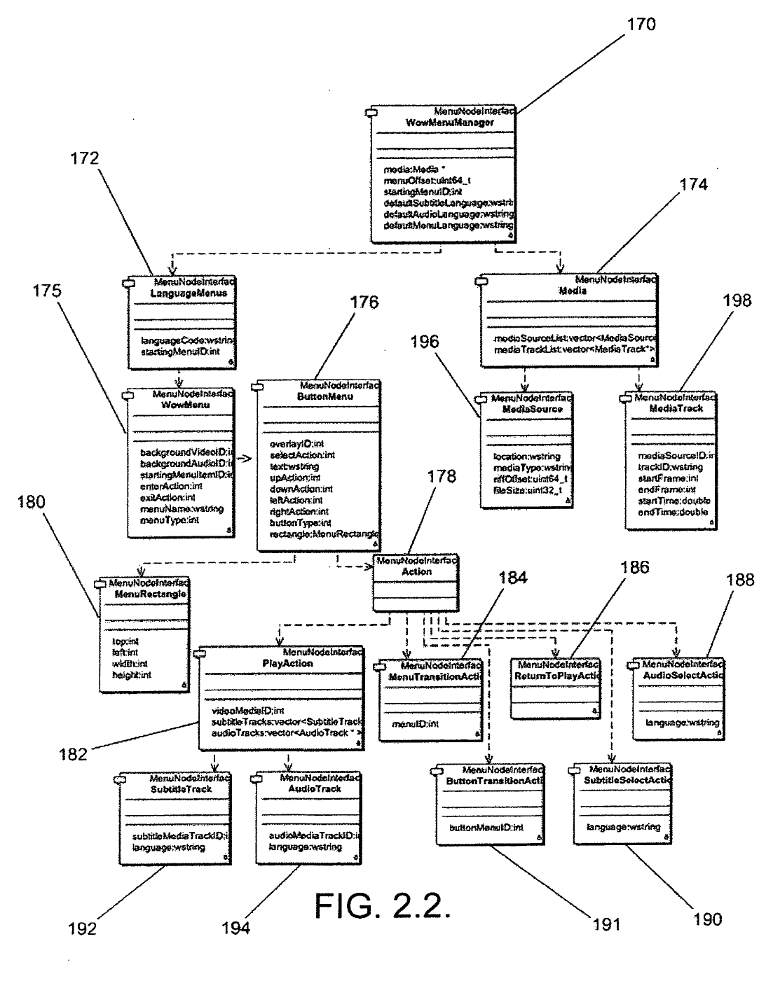

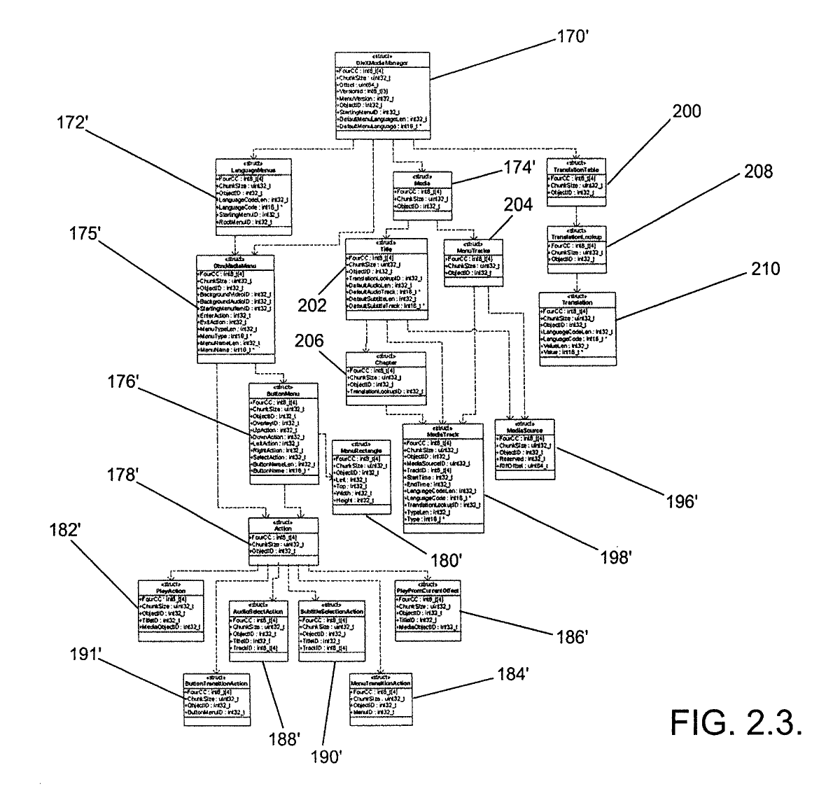

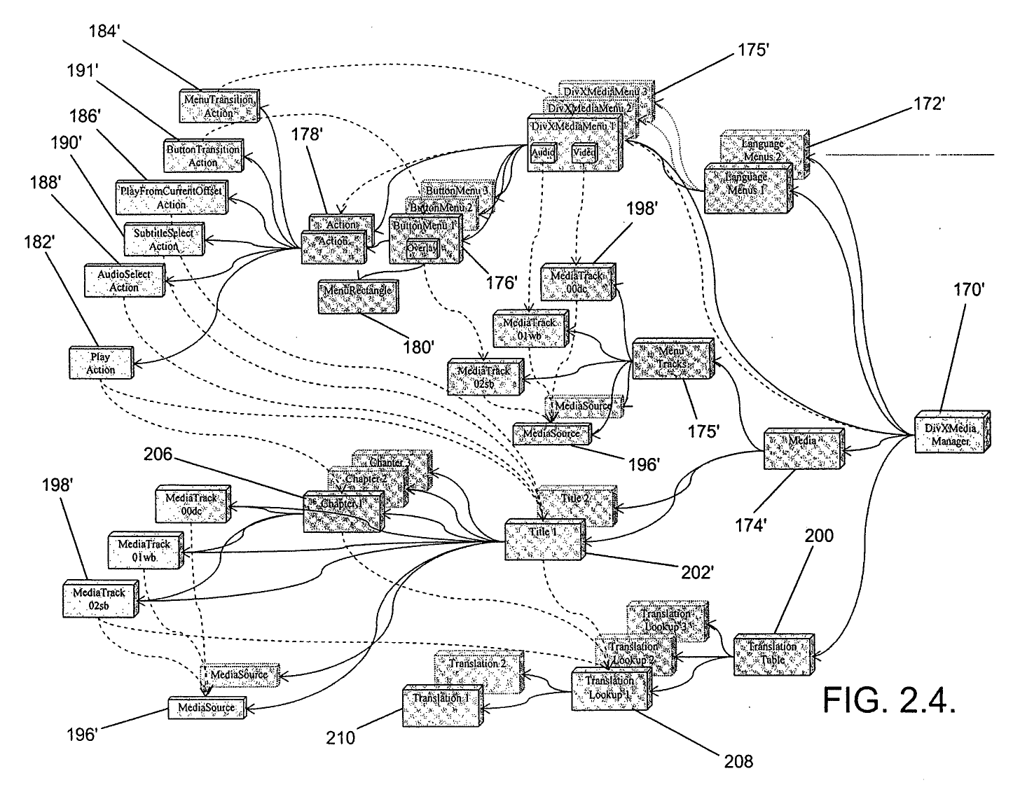

Examples of multimedia files complying with the file formats described in the above referenced patent applications are shown in FIGS. 2.0. and 2.0.1. As discussed above, the storage and display of still photos is facilitated using menu information that can be stored in such a multimedia file. In many embodiments, menu information is stored as a ‘DMNU’ chunk within the multimedia file. The information that can be contained within a ‘DMNU’ chunk, the creation of a ‘DMNU’ chunk that includes still photos encoded as video sequences and menu information to access the encoded video sequences and the decoding of such a ‘DMNU’ chunk are discussed below.

2.1. The ‘DMNU’ Chunk

Referring to FIGS. 2.0. and 2.0.1., a first ‘DMNU’ chunk 40 (40′) and a second ‘DMNU’ chunk 46 (46′) are shown. In FIG. 2.0. the second ‘DMNU’ chunk 46 forms part of the multimedia file 30. In the embodiment illustrated in FIG. 2.0.1., the ‘DU’ chunk 46′ is contained within a separate RIFF chunk. In both instances, the first and second ‘DMNU’ chunks contain data that can be used to display navigable menus and in many embodiments the navigable menus access still photos encoded as video sequences. In a number of embodiments, the first ‘DMNU’ 46 is not included and all of the menu information is contained within a ‘DMNU’ chunk 46′ that is located within a separate RIFF chunk.

The structure of a ‘DMNU’ chunk in accordance with an embodiment of the present invention is shown in FIG. 2.1. The ‘DMNU’ chunk 158 is a list chunk that contains a ‘MENU’ chunk 160 and one or more ‘MRIF’ chunks 162. The ‘MENU’ chunk contains the information necessary to construct and navigate through the menus. In many embodiments, the ‘MENU’ chunk 160 includes a number of chunks of data that define objects in a hierarchical state machine. The construction of a state machine using the information contained in an appropriately formatted ‘MENU’ chunk is discussed further below. In a number of embodiments, the ‘MENU’ chunk contains information that enables a decoder to operate a thumbnail menu and render encoded video sequences of still photos in response to user instructions. In the illustrated embodiment, each ‘MRIF’ chunk contains media information that can be used to provide subtitles, background video and background audio to the menus. In embodiments where still photos are encoded within the ‘DMNU’ chunk, the encoded video sequence for each still photo typically is contained within a separate ‘MRIF’ chunk. In embodiments where an encoded video sequence showing a slideshow of a number of still photos has been created, then the encoded video sequence for the slide show can also be contained within an ‘MEIF’ chunk. In several embodiments, the ‘DMNU’ chunk contains menu information enabling the display of menus in several different languages.

In one embodiment, the ‘MENU’ chunk 160 contains the hierarchy of menu chunk objects that are conceptually illustrated in FIG. 2.2. At the top of the hierarchy is the ‘DivXMediaManager’ chunk 170. The ‘DivXMediaManager’ chunk can contain one or more ‘LanguageMenus’ chunks 172, one ‘Media’ chunk 174 and one or more ‘DivXMediaMenu’ chunks 175.

Use of ‘LanguageMenus’ chunks 172 enables the ‘DMNU’ chunk 158 to contain menu information in different languages. Each ‘LanguageMenus’ chunk 172 contains the information used to generate a complete set of menus in a specified language. Therefore, the ‘LanguageMenus’ chunk includes an identifier that identifies the language of the information associated with the ‘LanguageMenus’ chunk. The ‘LanguageMenus’ chunk also includes a list of ‘DivXMediaMenu’ chunks 175.

Each ‘DivXMediaMenu’ chunk 175 contains all of the information to be displayed on the screen for a particular menu. This information can include background video (e.g. an encoded video sequence showing a thumbnail menu or the encoded video sequence for a still photo) and audio. The information can also include data concerning button actions that can be used to access other menus or to exit the menu and commence displaying a portion of the multimedia file. In one embodiment, the ‘DivXMediaMenu’ chunk 175 includes a list of references to media. These references refer to information contained in the ‘Media’ chunk 174, which will be discussed further below. The references to media can define the background video and background audio for a menu. The ‘DivXMediaMenu’ chunk 175 also defines an overlay that can be used to highlight a specific button, when a menu is first accessed.

In addition, each ‘DivXMediaMenu’ chunk 175 includes a number of ‘ButtonMenu’ chunks 176. Each ‘ButtonMenu’ chunk defines the properties of an onscreen button. The ‘ButtonMenu’ chunk can describe such things as the overlay to use when the button is highlighted by the user, the name of the button and what to do in response to various actions performed by a user navigating through the menu. The responses to actions are defined by referencing an ‘Action’ chunk 178. A single action, e.g. selecting a button, can result in a number of different varieties of action related chunks being accessed. In embodiments where the user is capable of interacting with the menu using a device such as a mouse that enables an on-screen pointer to move around the display in an unconstrained manner, the on-screen location of the buttons can be defined using a ‘MenuRectangle’ chunk 180. Knowledge of the on-screen location of the button enables a system to determine whether a user is selecting a button, when using a free ranging input device.

Each ‘Action’ chunk identifies one or more of a number of different varieties of action related chunks, which can include a ‘PlayAction’ chunk 182, a ‘MenuTransitionAction’ chunk 184, a ‘PlayFromCurrentOffsetAction’ chunk 186, an ‘AudioSelectAction’ chunk 188; a ‘SubtitileSelectAction’ chunk 190 and a ‘ButtonTransitionAction’ chunk 191. A ‘PlayAction’ chunk 182 identifies a portion of each of the video, audio and subtitle tracks within a multimedia file. The ‘PlayAction’ chunk references a portion of the video track using a reference to a ‘MediaTrack’ chunk (see discussion below). The ‘PlayAction’ chunk identifies audio and subtitle tracks using ‘SubtitleTrack’ 192 and ‘AudioTrack’ 194 chunks. The ‘SubtitleTrack’ and ‘AudioTrack’ chunks both contain references to a ‘MediaTrack’ chunk 198. When a ‘PlayAction’ chunk forms the basis of an action in accordance with embodiments of the present invention, the audio and subtitle tracks that are selected are determined by the values of variables set initially as defaults and then potentially modified by a user's interactions with the menu.

Each ‘MenuTransitionAction’ chunk 184 contains a reference to a ‘DivXMediaMenu’ chunk 175. This reference can be used to obtain information to transition to and display another menu.

Each ‘ReturnFromCurrentOffsetAction’ chunk 186 contains information enabling a player to return to a portion of the multimedia file that was being accessed prior to the user bringing up a menu.

Each ‘AudioSelectAction’ chunk 188 contains information that can be used to select a particular audio track. In one embodiment, the audio track is selected from audio tracks contained within a multimedia file in accordance with an embodiment of the present invention. In other embodiments, the audio track can be located in an externally referenced file.

Each ‘SubtitleSelectAction’ chunk 190 contains information that can be used to select a particular subtitle track. In one embodiment, the subtitle track is selected from a subtitle contained within a multimedia file in accordance with an embodiment of the present invention. In other embodiments, the subtitle track can be located in an externally referenced file.

Each ‘ButtonTransitionAction’ chunk 191 contains information that can be used to transition to another button in a menu, which need not necessarily be the same menu. This is performed after other actions associated with a button have been performed.

The ‘Media’ chunk 174 includes a number of ‘MediaSource’ chunks 166 and ‘MediaTrack’ chunks 198. The ‘Media’ chunk defines all of the multimedia tracks (e.g., audio, video, subtitle) used by the feature and the menu system. Each ‘MediaSource’ chunk 196 identifies a ‘RIFF’ or ‘MRIF’ chunk within the multimedia file in accordance with an embodiment of the present invention, which, in turn, can include multiple ‘RIFF’ or ‘MRIF’ chunks. Each ‘MediaTrack’ chunk 198 identifies a portion of a multimedia track within a ‘RIFF’ or ‘MRIF’ chunk specified by a ‘MediaSource’ chunk.

The ‘MRIF’ chunk 162 is, essentially, its own small multimedia file that complies with the RIFF format. The ‘MRIF’ chunk contains audio, video and subtitle tracks that can be used to provide background audio and video and overlays for menus. As discussed above, an ‘MRIF’ chunk can contain an encoded video sequence for a still photo, an encoded video sequence for a slideshow and/or an encoded video sequence for a background image for a thumbnail menu such as the thumbnail menu shown in FIG. 1. In many embodiments, an encoded video sequence for a still photo includes a single frame of encoded video. Although in a number of embodiments, the encoded video sequence for a still photo can include more than one encoded frame of video, where each video frame is identical. The ‘MRIF’ chunk can also contain video to be used as overlays to indicate highlighted menu buttons.

As discussed above, the various chunks that form part of a ‘DivXMediaMenu’ chunk 175 and the ‘DivXMediaMenu’ chunk itself contain references to actual media tracks. Each of these references is typically to a media track defined in the ‘hdrl’ LIST chunk of a ‘RIFF’ or ‘MRIF’ chunk.

Other chunks that can be used to create a ‘DMNU’ chunk in accordance with the present invention are shown in FIG. 2.3. The ‘DMNU’ chunk includes a ‘DivXMediaManager’ chunk 170′. The ‘DivXMediaManager’ chunk 170′ can contain at least one ‘LanguageMenus’ chunk 172′, at least one ‘Media’ chunk 174′, at least one ‘TranslationTable’ chunk 200 and one or more ‘DivXMediaMenu’ chunks 175.

The contents of the ‘LanguageMenus’ chunk 172′ is largely similar to that of the ‘LanguageMenus’ chunk 172 illustrated in FIG. 2.2. The main difference is that the ‘PlayAction’ chunk 182′ does not contain ‘SubtitleTrack’ chunks 192 and ‘AudioTrack’ chunks 194.

The ‘Media’ chunk 174′ is significantly different from the ‘Media’ chunk 174 shown in FIG. 2.2. The ‘Media’ chunk 174′ contains at least one ‘Title’ chunk 202 and at least one ‘MenuTracks’ chunk 204. The ‘Title’ chunk refers to a title within the multimedia file. As discussed above, multimedia files in accordance with embodiments of the present invention can include more than one title (e.g. multiple “albums” of still photos). The ‘MenuTracks’ chunk 204 contains information concerning media information that is used to create a menu display and the audio soundtrack and subtitles accompanying the display. In some embodiments, this information can create the impression that the user is viewing a digital photo album.

The ‘Title’ chunk can contain one or more ‘Chapter’ chunks 206. The ‘Chapter’ chunk 206 references a scene within a particular title. The ‘Chapter’ chunk 206 contains references to the portions of the video track, each audio track and each subtitle track that correspond to the scene indicated by the ‘Chapter’ chunk. If no ‘Chapter’ chunk 206 is present in the ‘Title’ chunk 202, then the ‘Title chunk contains references to the video, track, each audio track, and each subtitle track that correspond to the title. In one embodiment, the references are implemented using ‘MediaSource’ chunks 196′ and ‘MediaTrack’ chunks 198′ similar to those described above in relation to FIG. 2.2. In several embodiments, a ‘MediaTrack’ chunk references the appropriate portion of the video track and a number of additional ‘MediaTrack’ chunks each reference one of the audio tracks or subtitle tracks. In one embodiment, all of the audio tracks and subtitle tracks corresponding to a particular video track are referenced using separate ‘MediaTrack’ chunks.

As described above, the ‘MenuTracks’ chunks 204 contain references to the media that are used to generate the audio, video and overlay media of the menus. In one embodiment, the references to the media information are made using ‘MediaSource’ chunks 196′ and ‘MediaTrack’ chunks 198′ contained within the ‘MenuTracks’ chunk. In one embodiment, the ‘MediaSource’ chunks 196′ and ‘MediaTrack’ chunks 198′ are implemented in the manner described above in relation to FIG. 2.2.

The ‘TranslationTable’ chunk 200 can be used to contain text strings describing each title, chapter, and media track in a variety of languages. In one embodiment, the ‘TranslationTable’ chunk 200 includes at least one ‘TranslationLookup’ chunk 208. Each ‘TranslationLookup’ chunk 208 is associated with a ‘Title’ chunk 202, a ‘Chapter’ chunk 206 or a ‘MediaTrack’ chunk 196′ and contains a number of ‘Translation’ chunks 210. Each of the ‘Translation’ chunks in a ‘TranslationLookup’ chunk contains a text string that describes the chunk associated with the ‘TranslationLookup’ chunk in a language indicated by the ‘Translation’ chunk.

A diagram conceptually illustrating the relationships between the various chunks contained within a ‘DMNU’ chunk is illustrated in FIG. 2.4. The figure shows the containment of one chunk by another chunk using a solid arrow. The direction in which the arrow points indicates the chunk contained by the chunk from which the arrow originates. References by one chunk to another chunk are indicated by a dashed line, where the referenced chunk is indicated by the dashed arrow.

3. Creating a Multimedia File Containing Encoded Still Photos

Embodiments of the present invention can be used to generate multimedia files in a number of ways. In one instance, systems in accordance with embodiments of the present invention can generate multimedia files from files containing photos/images, video or audio and/or from separate video tracks, audio tracks and subtitle tracks. In such instances, other information such as menu information and ‘meta data’ can be authored and inserted into the file.

3.1. Generation Using Stored Data Tracks

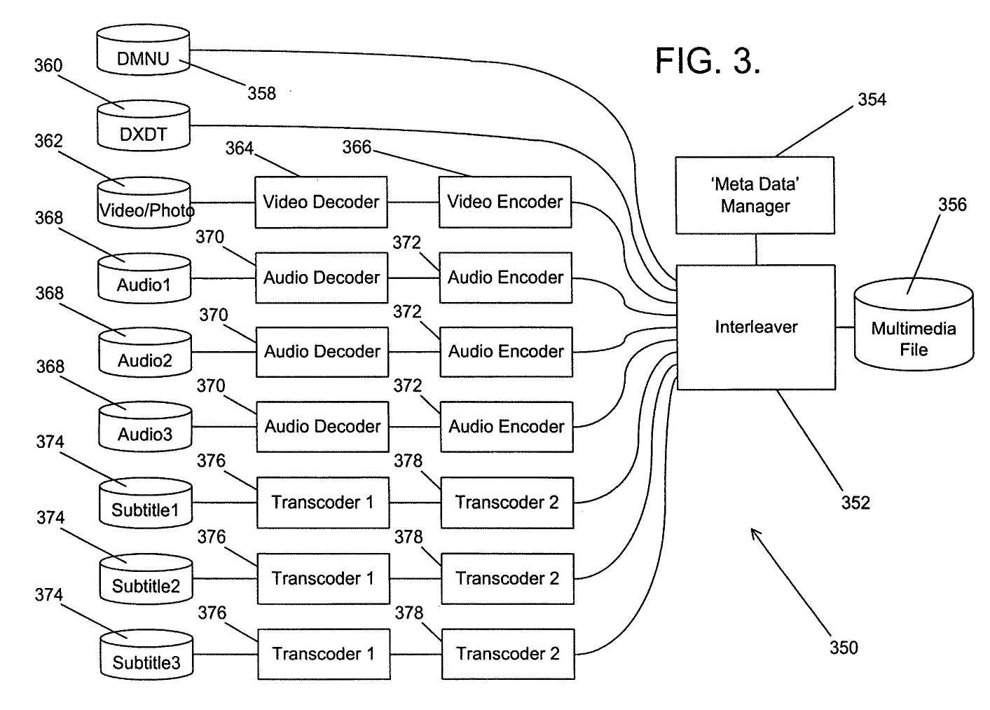

A system in accordance with an embodiment of the present invention for generating a multimedia file is illustrated in FIG. 3. The main component of the system 350 is the interleaver 352. The interleaver receives chunks of information and interleaves them to create a multimedia file in accordance with an embodiment of the present invention in the format described in the above-referenced PCT application. The interleaver also receives information concerning ‘meta data’ from a meta data manager 354. The interleaver outputs a multimedia file in accordance with embodiments of the present invention to a storage device 356.

Typically the chunks provided to the interleaver are stored on a storage device. In several embodiments, all of the chunks are stored on the same storage device. In other embodiments, the chunks may be provided to the interleaver from a variety of storage devices or generated and provided to the interleaver in real time.

In the embodiment illustrated in FIG. 3., the menu (‘DMNU’) chunk 358 and the ‘DXDT’ chunk 360 have already been generated and are stored on storage devices. The video or still photo source 362 is stored on a storage device and is decoded using a video decoder 364 and then encoded using a video encoder 366 to generate a ‘video’ chunk. The audio sources 368 are also stored on storage devices. Audio chunks are generated by decoding the audio source using an audio decoder 370 and then encoding the decoded audio using an audio encoder 372. ‘Subtitle’ chunks are generated from text subtitles 374 stored on a storage device. The subtitles are provided to a first transcoder 376, which converts any of a number of subtitle formats into a raw bitmap format. The output of the first transcoder 376 is provided to a second transcoder 378, which compresses the bitmap. In one embodiment run length coding is used to compress the bitmap. In other embodiments, other suitable compression formats are used.

In one embodiment, the interfaces between the various encoders, decoder and transcoders conform with Direct Show standards specified by Microsoft Corporation. In other embodiments, the software used to perform the encoding, decoding and transcoding need not comply with such standards.

In the illustrated embodiment, separate processing components are shown for each media source. In other embodiments resources can be shared. For example, a single audio decoder and audio encoder could be used to generate audio chunks from all of the sources. Typically, the entire system can be implemented on a computer using software and connected to a storage device such as a hard disk drive.

In order to utilize the interleaver in the manner described above, the ‘DMNU’ chunk, the ‘DXDT’ chunk, the ‘video’ chunks, the ‘audio’ chunks and the ‘subtitle’ chunks in accordance with embodiments of the present invention must be generated and provided to the interleaver. The process of generating the ‘DXDT’ chunk and the ‘audio’ and ‘subtitle’ chunks are described in detail in the above-referenced applications. Processes for generating the ‘DMNU’ and ‘video’ chunks are discussed in greater detail below.

3.2. Generating a ‘DMNU’ Chunk

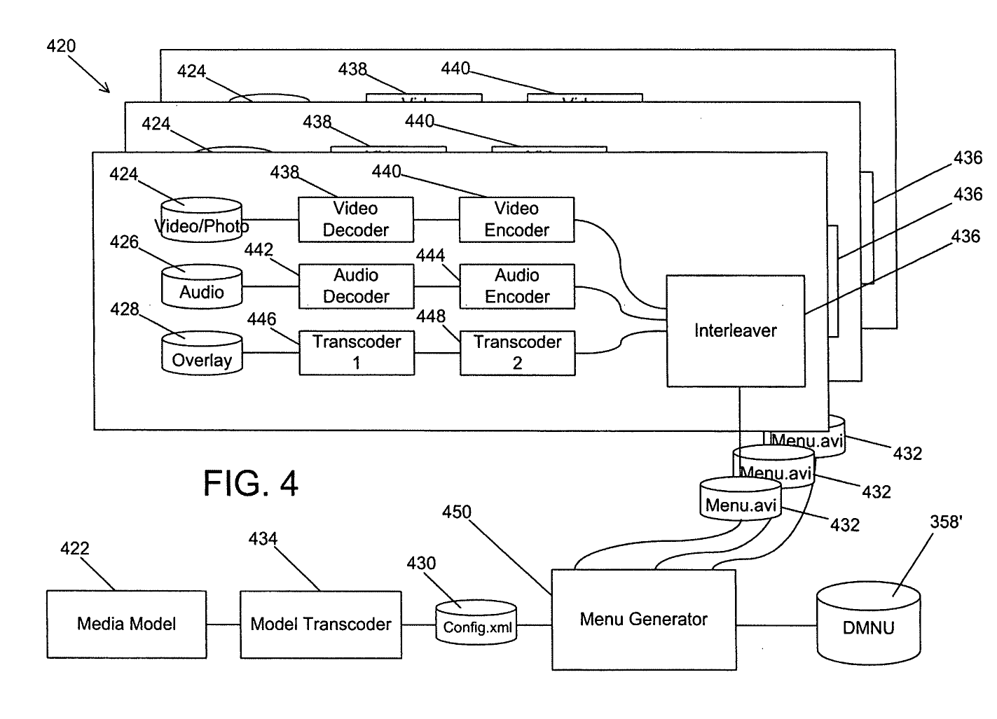

A system that can be used to generate a ‘DMNU’ chunk in accordance with an embodiment of the present invention is illustrated in FIG. 4. The menu chunk generating system 420 requires as input a media model 422 and media information. The media model is typically a model of a state machine that can be constructed by a decoder that can then use the model to determine the interactive behavior of the menu system. The media information can take the form of a video/photo source 424, an audio source 426 and an overlay source 428. As discussed above, the video/photo source can include one or more still photographs.

The generation of a ‘DMNU’ chunk using the inputs to the menu chunk generating system involves the creation of a number of intermediate files. The media model 422 is used to create an XML configuration file 430 and the media information is used to create a number of AVI files 432. The XML configuration file is created by a model transcoder 434. The AVI files 432 are created by interleaving the video, audio and overlay information using an interleaver 436. The video information is obtained by using a video decoder 438 and a video encoder 440 to decode the video/photo source 424 and recode it in the manner discussed below. The audio information is obtained by using an audio decoder 442 and an audio encoder 444 to decode the audio and encode it in the manner described below. The overlay information is generated using a first transcoder 446 and a second transcoder 448. The first transcoder 446 converts the overlay into a graphical representation such as a standard bitmap and the second transcoder takes the graphical information and formats it as is required for inclusion in the multimedia file. Once the XML file and the AVI files containing the information required to build the menus have been generated, the menu generator 450 can use the information to generate a ‘DMNU’ chunk 358′.

3.2.1. The Menu Model

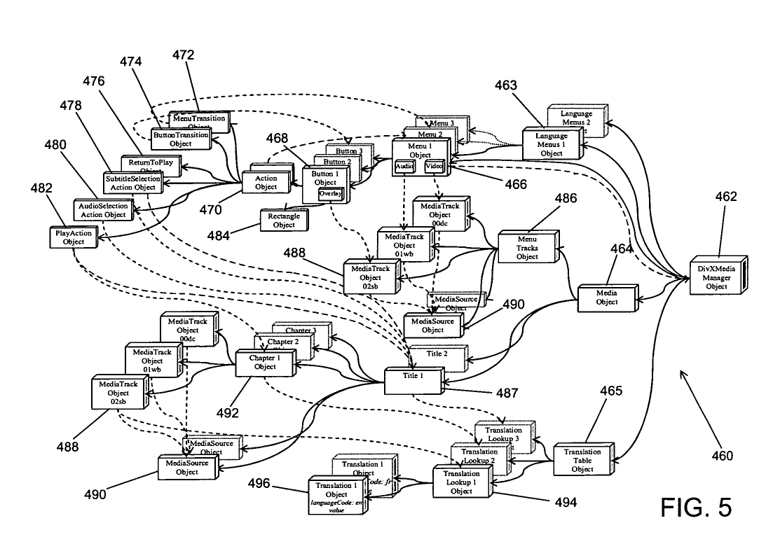

In one embodiment, the media model is an object-oriented model representing all of the menus and their subcomponents. The media model organizes the menus into a hierarchical structure, which allows the menus to be organized by language selection. A media model in accordance with an embodiment of the present invention that uses a parent/child hierarchical structure is illustrated in FIG. 5. The media model 460 includes a top-level ‘MediaManager’ object 462, which is associated with a number of ‘LanguageMenus’ objects 463, a ‘Media’ object 464 and a ‘TranslationTable’ object 465. The ‘Menu Manager’ also contains the default menu language. In one embodiment, the default language can be indicated by ISO 639 two-letter language code.

The ‘LanguageMenus’ objects organize information for various menus by language selection. All of the ‘Menu’ objects 466 for a given language are associated with the ‘LanguageMenus’ object 463 for that language. Each ‘Menu’ object is associated with a number of ‘Button’ objects 468 and references a number of ‘MediaTrack’ objects 488. Thus, when generating a menu of photo thumbnails, each photo thumbnail is represented by a ‘Button’ object which references a ‘MediaTrack’ object indicating the appropriate still video file of the associated photo.

Each ‘Button’ object 468 is associated with an ‘Action’ object 470 and a ‘Rectangle’ object 484. The ‘Button’ object 468 also contains a reference to a ‘MediaTrack’ object 488 that indicates the overlay to be used when the button is highlighted on a display. Each ‘Action’ object 470 is associated with a number of objects that can include a ‘MenuTransition’ object 472, a ‘ButtonTransition’ object 474, a ‘ReturnToPlay’ object 476, a ‘Subtitle Selection’ object 478, an ‘AudioSelection’ object 480 and a ‘PlayAction’ object 482. Each of these objects define the response of the menu system to various inputs from a user. The ‘MenuTransition’ object contains a reference to a ‘Menu’ object that indicates a menu that should be transitioned to in response to an action. The ‘ButtonTransition’ object indicates a button that should be highlighted in response to an action. The ‘ReturnToPlay’ object (also known as the ‘PlayFromCurrentOffset’ action) can cause a player to resume playing a feature. The ‘SubtitleSelection’ and ‘AudioSelection’ objects contain references to ‘Title’ objects 487 (discussed below). The ‘PlayAction’ object contains a reference to a ‘Chapter’ object 492 (discussed below). The ‘Rectangle’ object 484 indicates the portion of the screen occupied by the button.

The ‘Media’ object 464 indicates the media information referenced in the menu system. The ‘Media’ object has a ‘MenuTracks’ object 486 and a number of ‘Title’ objects 487 associated with it. The ‘MenuTracks’ object 486 references ‘MediaTrack’ objects 488 that are indicative of the media used to construct the menus (i.e. background audio, background video and overlays).

The ‘Title’ objects 487 are indicative of a multimedia presentation and have a number of ‘Chapter’ objects 492 and ‘MediaSource’ objects 490 associated with them. The ‘Title’ objects also contain a reference to a ‘TranslationLookup’ object 494. The ‘Chapter’ objects are indicative of a certain point in a multimedia presentation and have a number of ‘MediaTrack’ objects 488 associated with them. The ‘Chapter’ objects also contain a reference a ‘TranslationLookup’ object 494. Each ‘MediaTrack’ object associated with a ‘Chapter’ object is indicative of a point in either an audio, video or subtitle track of the multimedia presentation and references a ‘MediaSource’ object 490 and a ‘TransalationLookup’ object 494 (discussed below).

The ‘TranslationTable’ object 465 groups a number of text strings that describe the various parts of multimedia presentations indicated by the ‘Title’ objects, the ‘Chapter’ objects and the ‘MediaTrack’ objects. The ‘TranslationTable’ object 465 has a number of ‘TranslationLookup’ objects 494 associated with it. Each ‘TranslationLookup’ object is indicative of a particular object and has a number of ‘Translation’ objects 496 associated with it. The ‘Translation’ objects are each indicative of a text string that describes the object indicated by the ‘TranslationLookup’ object in a particular language.

A media object model can be constructed using software configured to generate the various objects described above and to establish the required associations and references between the objects.

3.3. Generating ‘Video’ Chunks

As described above the process of creating ‘video’ chunks can involve decoding a video/photo source and encoding the decoded video/photo into ‘video’ chunks. In one embodiment, each ‘video’ chunk contains information for a single frame of video. The decoding process simply involves taking video in a particular format and decoding the video from that format into a standard video format, which may be uncompressed. The encoding process involves taking the standard video, encoding the video and generating ‘video’ chunks using the encoded video. When the source is a photo source instead of a video source, the encoder encodes the photo image into a single frame of video and generates a single ‘video’ chunk containing information for the single video frame. During playback, the player plays the single frame of video and a menu end action is performed. According to one embodiment of the invention, the menu end action is a redirect to play the same menu again. Thus, the menu is replayed over and over again until the user transmits a different command.

4. Decoding a Multimedia File

Information from a multimedia file in accordance with an embodiment of the present invention can be accessed by a computer configured using appropriate software, a dedicated player that is hardwired to access information from the multimedia file or any other device capable of parsing an AVI file. In several embodiments, devices can access all of the information in the multimedia file. In other embodiments, a device may be incapable of accessing all of the information in a multimedia file in accordance with an embodiment of the present invention. In a particular embodiment, a device is not capable of accessing any of the information described above that is stored in chunks that are not specified in the AVI file format. In embodiments where not all of the information can be accessed, the device will typically discard those chunks that are not recognized by the device.

Typically, a device that is capable of accessing the information contained in a multimedia file in accordance with an embodiment of the present invention is capable of performing a number of functions. The device can display a multimedia presentation involving display of video, whether it be a still or moving video, on a visual display, generate audio from one of potentially a number of audio tracks on an audio system and display subtitles from potentially one of a number of subtitle tracks. Several embodiments extract menu information from the file and use the menu information to form a state machine that defines the menus that are rendered and any accompanying audio and/or video. The relationships defined in the state machine can enable the menus to be interactive, with features such as selectable buttons, pull down menus and sub-menus. As discussed above, appropriately encoded still photographs and an appropriately structured menu system can give the appearance of an interactive slide show or photo album. In some embodiments, menu information can point to audio/video content outside the multimedia file presently being accessed. The outside content may be either located local to the device accessing the multimedia file or it may be located remotely, such as over a local area, wide area or public network. Many embodiments can also search one or more multimedia files according to ‘meta data’ included within the multimedia file(s) or ‘meta data’ referenced by one or more of the multimedia files.

4.1. Generation of Menus

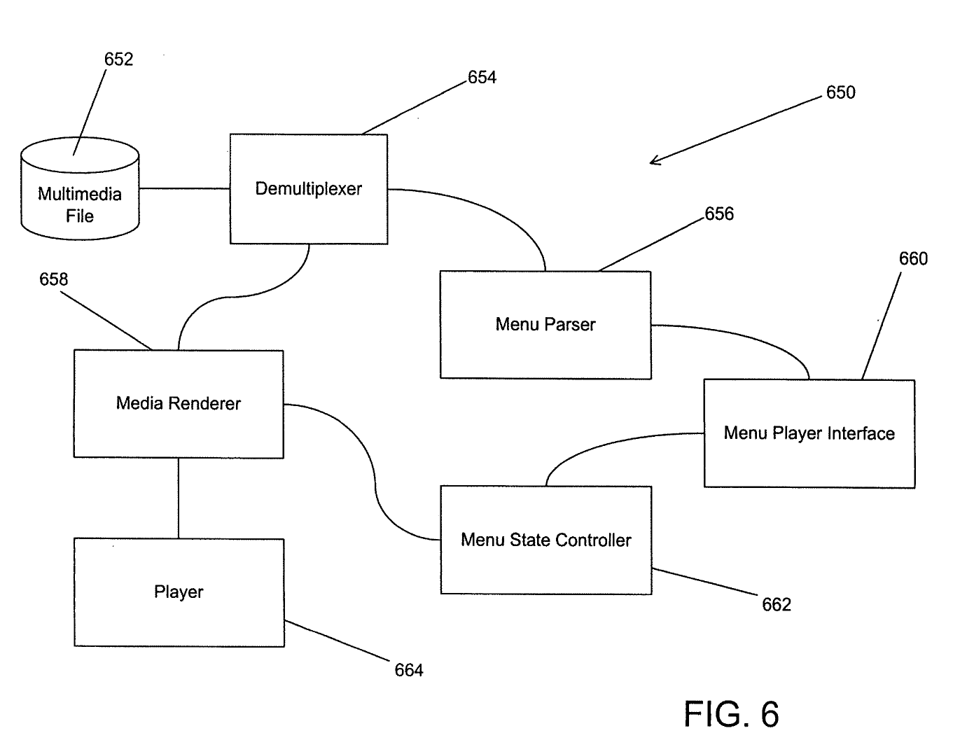

A decoder in accordance with an embodiment of the present invention is illustrated in FIG. 6. The decoder 650 processes a multimedia file 652 in accordance with an embodiment of the present invention by providing the file to a demultiplexer 654. The demultiplexer extracts the ‘DMNU’ chunk from the multimedia file and extracts all of the ‘LanguageMenus’ chunks from the ‘DMNU’ chunk and provides them to a menu parser 656. The demultiplexer also extracts all of the ‘Media’ chunks from the ‘DMNU’ chunk and provides them to a media renderer 658. The menu parser 656 parses information from the ‘LanguageMenu’ chunks to build a state machine representing the menu structure defined in the ‘LanguageMenu’ chunk. The state machine representing the menu structure can be used to provide displays to the user and to respond to user commands. In many embodiments, all of the ‘LanguageMenu’ chunks are parsed and the information used to form a state machine within the decoder prior to the generation of menu displays. Once a state machine has been generated by the decoder, the state machine is provided to a menu state controller 660. The menu state controller keeps track of the current state of the menu state machine and receives commands from the user. The commands from the user can cause a state transition. The initial display provided to a user and any updates to the display accompanying a menu state transition can be controlled using a menu player interface 662. The menu player interface 662 can be connected to the menu state controller and the media renderer. The menu player interface instructs the media renderer which media should be extracted from the media chunks and provided to the user via the player 664 connected to the media renderer. The user can provide the player with instructions using an input device such as a keyboard, mouse or remote control. Generally the multimedia file dictates the menu initially displayed to the user and the user's instructions dictate the audio and/or still or moving video displayed following the generation of the initial menu. The system illustrated in FIG. 6 can be implemented using a computer and software. In other embodiments, the system can be implemented using function specific integrated circuits or a combination of software and firmware.

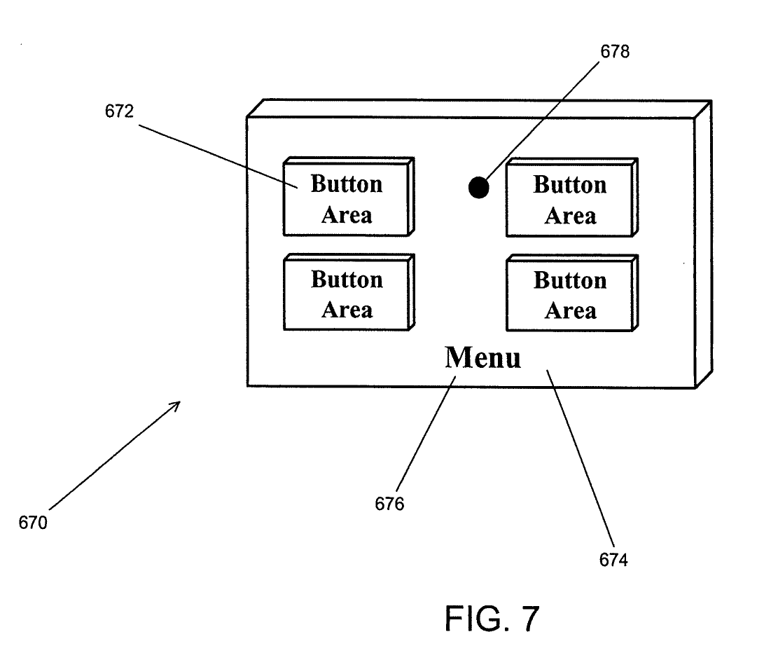

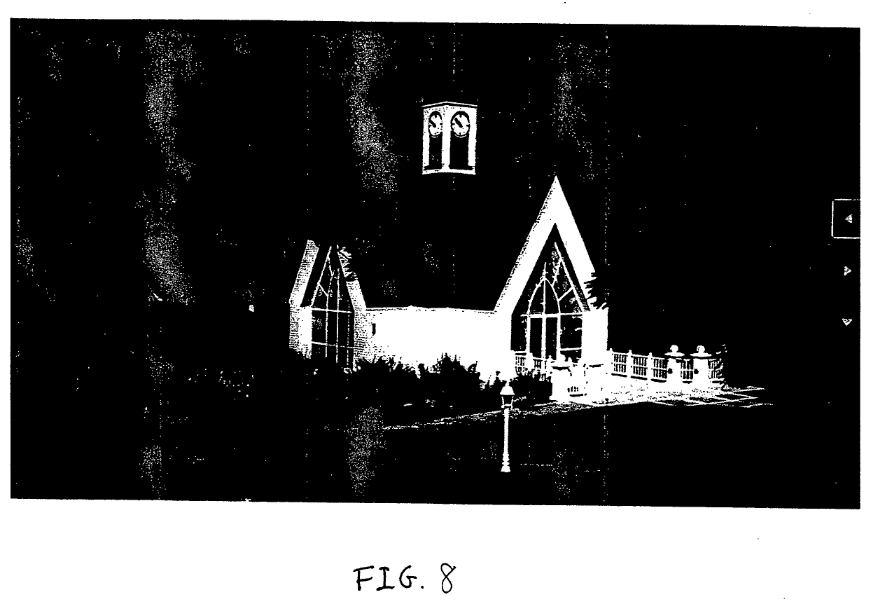

An example of a menu in accordance with an embodiment of the present invention is illustrated in FIG. 7. The menu display 670 includes four button areas 672, background video 674, including a title 676, and/or a pointer 678. The menu may also include background audio (not shown). In the event that the menu is a menu of photo thumbnails, each button area displays a particular photo thumbnail. The visual effect created by the display can be deceptive. The visual appearance of the buttons is typically part of the background video and the buttons themselves are simply defined regions of the background video that have particular actions associated with them, when the region is activated by the pointer. The pointer is typically an overlay. The effect can be seen in FIG. 8, which shows a background video sequence that appears to the viewer as a still photograph with a number of buttons. In addition, an overlay highlights one of the buttons to assist the user in navigating between buttons. A logo can also be shown as an overlay.

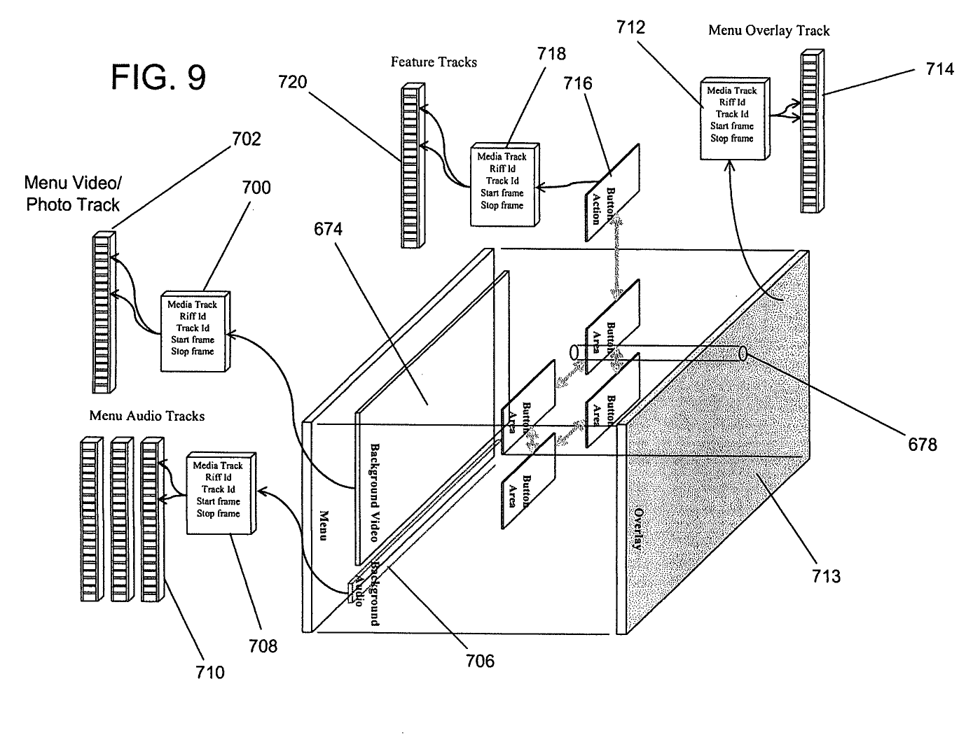

FIG. 9 conceptually illustrates the source of all of the information in the display shown in FIG. 6. The background video 674 can include a menu title, the visual appearance of the buttons and the background of the display. All of these elements and additional elements can appear static or animated. The background video is extracted by using information contained in a ‘MediaTrack’ chunk 700 that indicates the location of background video within a video track 702. In many embodiments, a number of still photos are encoded as separate tracks of video. The background audio 706 that can accompany the menu can be located using a ‘MediaTrack’ chunk 708 that indicates the location of the background audio within an audio track 710. As described above, the pointer 678 is part of an overlay 713. The overlay 713 can also include graphics that appear to highlight the portion of the background video that appears as a button. In one embodiment, the overlay 713 is obtained using a ‘MediaTrack’ chunk 712 that indicates the location of the overlay within a overlay track 714. The manner in which the menu interacts with a user is defined by the ‘Action’ chunks (not shown) associated with each of the buttons. In the illustrated embodiment, a ‘PlayAction’ chunk 716 is illustrated. The ‘PlayAction’ chunk indirectly references (the other chunks referenced by the ‘PlayAction’ chunk are not shown) a scene within a multimedia presentation contained within the multimedia file (i.e. an audio, still or moving video, and/or possibly a subtitle track). The ‘PlayAction’ chunk 716 ultimately references the scene using a ‘MediaTrack’ chunk 718, which indicates the scene within the feature track. A point in a selected or default audio track and potentially a subtitle track may also be referenced.

As the user enters commands using the input device, the display may be updated not only in response to the selection of button areas but also simply due to the pointer being located within a button area. As discussed above, typically all of the media information used to generate the menus is located within the multimedia file and more specifically within a ‘DMNU’ chunk. Although in other embodiments, the information can be located elsewhere within the file and/or in other files.

Many embodiments of decoders in accordance with the present invention include the capability of resizing video sequences for display. In these embodiments, information in the multimedia file associated with a particular video sequence provides information concerning the resolution and/or the aspect ratio of the video sequence. In instances where the aspect ration or the resolution of the video sequence conflicts with the aspect ratio or resolution of the rendering device connected to the decoder, the decoder can resize the video sequence for display on the rendering device. In embodiments where the encoded video sequence is of a higher resolution than the rendering device, then the encoded video sequence can be resampled by the decoder for display. In embodiments where the encoded video sequence is of lower resolution than the resolution of the rendering device, then the decoder can automatically reduce the proportion of the screen occupied by the rendered video sequence. In instances where the aspect rations conflict, the decoder can crop, change the height and/or width of the video sequence and/or insert blocks (i.e. bands of uniform color) to frame the rendered video sequence.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicants intention to cover all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

What is claimed is:

1. A multimedia file, comprising:
at least one still photo encoded as an encoded video sequence; and
menu information that references the location of each encoded video sequence.

2. The multimedia file of claim 1, wherein each encoded video sequence is stored within the multimedia file as a separate track of encoded video.

3. The multimedia file of claim 2, wherein each track of encoded video complies with the RIFF format.

4. The multimedia file of claim 1, wherein the menu information includes references to encoded video sequences that provide background video and references to information that can be used to generate menu overlays.

5. The multimedia file of claim 1, wherein the menu information includes information directing that an encoded video sequence of a still photo be repeatedly displayed until interrupted by a user instruction.

6. The multimedia file of claim 1, wherein the menu information defines a state machine.

7. The multimedia file of claims 6, wherein the state machine is hierarchical.

8. The multimedia file of claim 7, wherein the state machine includes a parent/child hierarchy.

9. The multimedia file of claim 1, further comprising encoded audio information.

10. The multimedia file of claim 1, wherein each video sequence includes at least one encoded frame of video.

11. The multimedia file of claim 1, wherein each video sequence includes a plurality of encoded frames of video.

12. An encoder that receives at least one digital still photo in a digital still photo format, comprising:
a video encoder configured to encode the at least one digital still photo as an encoded video sequence; and
a menu generator configured to generate menu information that references the encoded video sequences within a multimedia file.

13. The encoder of claim 12, wherein the video encoder is configured to encode the at least one digital still photo as an encoded video sequence by decoding the digital still photo and encoded the decoded digital image as an encoded video sequence.

14. The encoder of claim 13, wherein the video encoder and menu generator are implemented using a microprocessor.

15. The encoder of claim 13, wherein each encoded video sequence includes at least one frame of encoded video.

16. The encoder of claim 15, wherein each encoded video sequence includes a plurality of frames of encoded video.

17. The encoder of claim 15, wherein the menu information includes a direction to repeatedly play an encoded video sequence until a user instruction is received.

18. The encoder of claim 9, wherein the menu information defines a state machine.

19. The encoder of claim 18, wherein the state machine is hierarchical.

20. The encoder of claim 19, wherein the hierarchy is a parent/child hierarchy.

21. A decoder configured to decode multimedia files containing encoded video sequences of still photos and menu information that defines a state machine, comprising:
decoding circuitry configured to decode encoded video sequences; and
a parser configured to construct a state machine from the menu information.

22. The decoder of claim 21, wherein the state machine is hierarchical.

23. The decoder of claim 22, wherein the hierarchy is a parent/child hierarchy.

24. The decoder of claim 21, further comprising control circuitry configured to use the state machine and user instructions to determine when to display the encoded video sequences of still photos.

25. The decoder of claim 24, wherein:
the state machine defined by the menu information includes a direction to repeatedly display one of the encoded video sequences of a still photo until a user instruction is received for output on a rendering device; and
the control circuitry is configured to respond to the direction to repeatedly display a video sequence until interrupted by a user command by repeatedly decoding an encoded video sequence, outputting the decoded video sequence and waiting for a user command.

26. The decoder of claim 21, wherein the encoded video sequence includes a single encoded video frame.

27. The decoder of claim 21, wherein the encoded video sequence includes a plurality of encoded video frames.

28. The decoder of claim 21, wherein the decoder is configured to resize the encoded video sequence for display on the rendering device.

29. The decoder of claim 28, wherein the resizing includes resampling the video sequence.

30. The decoder of claim 28, wherein the resizing includes cropping the video sequence.

31. The decoder of claim 28, wherein resizing includes reducing the size of the video sequence to occupy a smaller area of the rendered display.

32. The decoder of claim 21, wherein the state machine is hierarchical state machine.

33. The decoder of claim 32, wherein the hierarchy is a parent/child hierarchy.
